(19) United States
(12) Patent Application Publication
(10) Pub. No.: US 2025/0171270 A1
(43) Pub. Date: May 29, 2025

(54) METHOD FOR TRAINING MULTIPLE ARTIFICIAL NEURAL NETWORKS TO ASSIGN CALLS TO CARS OF AN ELEVATOR

(71) Applicant: Inventio AG, Hergiswil (CH)

(72) Inventors: Nicola Ischia, Milano (IT); Pedro Candeias Martins, Niederglatt (CH)

(21) Appl. No.: 18/993,620

(22) PCT Filed: Jul. 13, 2023
(86) PCT No.: PCT/EP2023/069413

§ 371 Date: Jan. 13, 2025

(30) Foreign Application Priority Data
Jul. 19, 2022 (EP) 22185602.4

(51) Int. Cl. B66B 1/06; B66B 1/34; G06N 3/045; G06N 3/092

(52) U.S. Cl. CPC B66B 1/06; B66B 1/3492; G06N 3/045; G06N 3/092; B66B 2201/231; B66B 2201/30; B66B 2201/403

(57) ABSTRACT

A method for training neural networks to assign calls to elevator cars simulates an environment in which first and second cars move between building floors in reaction to calls indicating desired floors, each simulation including steps: determining a current state of the environment including a current position of each car, a list of current calls and a new call; inputting first and second input data encoding at least a part of the current state into respective first and second neural networks each configured to convert the input data into output values indicating a probability and/or tendency for the cars to be assigned to the new call; determining a selected car using the output values; assigning the new call to the selected car, and determining reward values quantifying a usefulness of the assignment; training the neural networks using past simulation reward values to increase the usefulness of future assignments.

### FIELD

The invention relates to a method for training multiple artificial neural networks to assign calls to cars of an elevator. The invention further relates to an elevator and a method for controlling an elevator, as well as to a data processing device, a computer program and a computer-readable medium for carrying out one or both of these methods.

### BACKGROUND

An elevator may comprise different cars for transporting people and/or objects along different vertical shafts between different floors of a building. Given a list of calls indicating desired floors of the building, the controller of the elevator needs to be able to assign each call to one of the cars and determine the order of the floors at which the cars should stop to fulfil the assigned calls in an efficient manner. This may also be referred to as trip scheduling.

Especially in very tall buildings with multiple floors and multiple elevators operating at the same time, solving the trip scheduling problem using conventional elevator control algorithms, which are usually based on a set of known rules, may become very complex. In such scenarios, a machine-learning model may be utilized to make better control decisions. Such models are usually trained using reinforcement learning, where actions of a simulated elevator (“agent”) are evaluated with rewards and an algorithm that controls the agent (e.g. in the form of an artificial neural network) is optimized according to the rewards so that future control decisions are better than past control decisions.

CN 113479727 A discloses a method for training an artificial neural network to estimate control commands for controlling an elevator.

### SUMMARY

It may be seen as an objective of the invention to provide an improved machine-learning model for controlling an elevator that comprises two or more cars. Another objective of the invention may be to provide an improved method for controlling an elevator, a corresponding elevator, a corresponding data processing device, a corresponding computer program and a corresponding computer-readable medium.

These objectives may be achieved by the subject matter of the advantageous embodiments defined in the following description and the attached drawings.

A first aspect of the invention relates to a computer-implemented method for training multiple artificial neural networks to assign calls to cars of an elevator. The method comprises: (1) simulating, in a series of simulation steps, an environment in which at least a first car and a second car of the elevator move along different vertical axes between different floors of a building in reaction to calls indicating desired floors of the building, wherein each simulation step comprises: (1.1) determining a current state of the environment, the current state including a current position of each car with respect to the floors, a list of current calls assigned to the cars and a new call to be assigned to one of the cars; (1.2) inputting first input data encoding at least a part of the current state into a first artificial neural network configured to convert the first input data into a first output value indicating a probability and/or tendency for the first car to be assigned to the new call; (1.3) inputting second input data encoding at least a part of the current state into a second artificial neural network configured to convert the second input data into a second output value indicating a probability and/or tendency for the second car to be assigned to the new call; (1.4) determining one of the cars as a selected car using the first output value and the second output value; (1.5) updating the environment by assigning the new call to the selected car, wherein a first reward value and a second reward value are determined, wherein each reward value quantifies a usefulness of the assignment; (2) training the first artificial neural network using training data including the first reward values from past simulation steps and training the second artificial neural network using training data including the second reward values from past simulation steps to increase the usefulness of assignments performed at future simulation steps.

According to the invention, the first reward value is additionally increased or decreased if the new call is assigned to the first car as the selected car (2.1). Additionally or alternatively, the second reward value is additionally increased or decreased if the new call is assigned to the second car as the selected car (2.2). This has the effect of forcing the artificial neural networks to compete with each other, which leads to multiple artificial neural networks trained to achieve an effective control of an elevator. High efficiency of an elevator controller is reflected in particular in low waiting times for passengers and/or a high transport capacity.

The environment may be seen as a computer-calculated space the (virtual) elevator takes actions in. Each artificial neural network may be seen as an agent (or as a component of such an agent) in a multi-agent environment, i.e. multi-agent reinforcement learning (MARL) framework, in which the agents take actions independently of each other while collaborating toward the same objective. This is achieved by providing each agent with observations of at least a part of the state of the environment and rewards related to these observations.

As an example, the simulation of the environment may comprise the following components: elevator simulation, traffic simulation, interaction between elevator simulation and traffic simulation. The elevator simulation may be configured with at least one of the following parameters: maximum velocity, acceleration, door opening time, door closing time, minimum door open time, car capacity. The traffic simulation may be performed according to a specific traffic pattern that determines a local and/or temporal distribution of the calls. For example, each call may be characterized by a unique ID, a timestamp, an origin floor and a destination floor. The traffic pattern may be varied during simulation. The simulation of the interaction between the elevator and the calls (i.e. the passengers) may be configured with parameters such as a waiting time (i.e. the time a passenger waits before entering the car), a travelling time (i.e. the time a passenger travels before leaving the car) or a destination time (i.e. the overall time it takes to fulfil a call).

In general, as mentioned above, the agents may be configured to receive an observation of the environment in each simulation step and execute an action depending on the observation, e.g. assign a new call to one of the cars and, optionally, control the car accordingly. As a reaction, the environment may update its state and emit an observation of its updated state together with a reward, which is then used to train the agents to improve their actions executed at future simulation steps.

For example, there may be as many agents, i.e. artificial neural networks, as the elevator has cars arranged to be movable independently of each other.

The state of the environment may be seen as a combination of both an elevator state and a traffic state. The elevator state may be defined, for example, by at least one of the following parameters: a current floor of each car, a current moving direction of each car, a current door status (opened, moving, closed) of each car, a current number of passengers inside each car, the next reachable floors of each car. The traffic state may be defined, for example, by at least one of the following parameters: active calls from and/or to each floor, a current number of passengers inside each car, a current number of passengers waiting on each floor.

Each input data may encode at least a part of the current state in a format specifically adapted to the artificial neural network, e.g. in the form of a vector. The first input data and the second input data may encode the same part or different parts of the current state. In other words, the first input data and the second input data may be identical or differ from each other. Encoding at least a part of the current state may also mean indicating a possible order of floors at which the respective car should stop to fulfil the respective current calls and the new call. It is also possible that both input data encode the complete current state.

The current position of each car may be an ID of a floor on or near which the car is currently located.

Each output value may be a value from a discrete and/or continuous value range, such as a Q value or bid value. However, each output value may also be a percentage between 0 and 1 or a Boolean value.

Each artificial neural network may be, for example, a multilayer perceptron (MLP), a convolutional neural network (CNN), a recurrent neural network (RNN), a long short-term memory (LSTM), a graph neural network (GNN) or a combination of at least two of these examples.

The agent implemented by each artificial neural network may be policy-based, value-based or a combination of both, i.e. an actor-critic agent.

The selected car may be determined with a certain degree of randomness, e.g. by using an epsilon-greedy algorithm and/or by calculating a probability distribution based on the output values and determining the selected car according to the probability distribution. The degree of randomness may be varied, in particular reduced, as the training progresses, e.g. between consecutive training steps.

Each reward value may be positive, negative or zero. For example, a positive reward value may indicate a “more useful” assignment, whereas a negative reward value may indicate a “less useful” assignment. The reward values may be calculated in regular time intervals or only in certain situations, e.g. when a transition of the environment from the current state to the next state is observed. The second reward value may be equal to or differ from the first reward value.

The steps of simulating and training may be performed in parallel and/or alternately.

The trained first artificial neural network and the trained second artificial neural network may be regarded as products directly obtained by the method.

A second aspect of the invention relates to a computer-implemented method for controlling an elevator, wherein the elevator comprises a first car and a second car arranged to be movable along different vertical axes between different floors of a building and a sensor system adapted to provide sensor data indicative of a current state of the elevator. The method comprises: receiving the sensor data, wherein the sensor data includes a current position of each car with respect to the floors, a list of current calls assigned to the cars and a new call to be assigned to one of the cars, wherein each call indicates a desired floor of the building; inputting first input data generated from at least a part of the sensor data into a first artificial neural network configured to convert the first input data into a first output value indicating a probability and/or tendency for the first car to be assigned to the new call, wherein the first artificial neural network has been trained with the method described above and below; inputting second input data generated from at least a part of the sensor data into a second artificial neural network configured to convert the second input data into a second output value indicating a probability and/or tendency for the second car to be assigned to the new call, wherein the second artificial neural network has been trained with the method described above and below; determining one of the cars as a selected car using the first output value and the second output value; assigning the new call to the selected car. This leads to a high efficiency of the control of the elevator. High efficiency of an elevator controller is reflected in particular in low waiting times for passengers and/or a high transport capacity.

The first input data and the second input data may be generated from the same part or from different parts of the sensor data. It is also possible that both input data are generated from the complete sensor data.

This means that first multiple artificial neural networks are trained to assign calls to cars of an elevator a method described above then the trained networks are used for controlling an elevator with at least two cars. This results in a computer-implemented method for training multiple artificial neural networks to assign calls to cars of an elevator and for controlling an elevator, wherein the elevator comprises a first car and a second car arranged to be movable along different vertical axes between different floors of a building and a sensor system adapted to provide sensor data indicative of a current state of the elevator. For training of multiple artificial neural networks the method comprises the steps:

(1) simulating, in a series of simulation steps, an environment in which at least a first car and a second car of the elevator move along different vertical axes between different floors of a building in reaction to calls indicating desired floors of the building, wherein each simulation step comprises: (1.1) determining a current state of the environment, the current state including a current position of each car with respect to the floors, a list of current calls assigned to the cars and a new call to be assigned to one of the cars; (1.2) inputting first input data encoding at least a part of the current state into a first artificial neural network configured to convert the first input data into a first output value indicating a probability and/or tendency for the first car to be assigned to the new call; (1.3) inputting second input data encoding at least a part of the current state into a second artificial neural network configured to convert the second input data into a second output value indicating a probability and/or tendency for the second car to be assigned to the new call; (1.4) determining one of the cars as a selected car using the first output value and the second output value; (1.5) updating the environment by assigning the new call to the selected car, wherein a first reward value and a second reward value are determined, wherein each reward value quantifies a usefulness of the assignment; (2) training the first artificial neural network using training data including the first reward values from past simulation steps and training the second artificial neural network using training data including the second reward values from past simulation steps to increase the usefulness of assignments performed at future simulation steps; (2.1) increasing or decreasing the first reward value if the new call is assigned to the first car as the selected car (2.1); (2.2) additionally or alternatively, increasing or decreasing the second reward value if the new call is assigned to the second car as the selected car (2.2).

For controlling an elevator the method comprises the steps: (3) receiving the sensor data, wherein the sensor data includes a current position of each car with respect to the floors, a list of current calls assigned to the cars and a new call to be assigned to one of the cars, wherein each call indicates a desired floor of the building; (4) inputting first input data generated from at least a part of the sensor data into a first artificial neural network configured to convert the first input data into a first output value indicating a probability and/or tendency for the first car to be assigned to the new call, wherein the first artificial neural network has been trained with the method described above and below; (4) inputting second input data generated from at least a part of the sensor data into a second artificial neural network configured to convert the second input data into a second output value indicating a probability and/or tendency for the second car to be assigned to the new call, wherein the second artificial neural network has been trained with the method described above; (5) determining one of the cars as a selected car using the first output value and the second output value; (6) assigning the new call to the selected car.

The methods described above and below may be carried out automatically by a processor; especially a processor of an elevator controller.

A third aspect of the invention relates to a data processing device comprising a processor configured to carry out one or both of the methods described above and below. The data processing device may include hardware and/or software modules. In addition to the processor, the data processing device may comprise a memory and one or more data communication interfaces for data communication with peripheral devices. For example, the data processing device may be a (cloud) server, a PC, a laptop, an elevator group controller, an elevator controller, an elevator car controller or a combination of at least two of these examples.

A fourth aspect of the invention relates to an elevator. The elevator comprises: a first car and a second car arranged to be movable along different vertical axes between different floors of a building; a sensor system adapted to provide sensor data indicative of a current state of the elevator, wherein the sensor data includes a current position of each car with respect to the floors, a list of current calls assigned to the cars and a new call to be assigned to one of the cars, wherein each call indicates a desired floor of the building; the data processing device described above and below.

For example, the cars may be arranged to be movable along different shafts of the building. In particular, each car may be arranged to be movable in its own shaft.

Further aspects of the invention relate to a computer program comprising instructions which, when the program is executed by a processor, cause the processor to carry out one or both of the methods described above and below, as well as to a computer-readable medium in which the computer program is stored.

The computer-readable medium may be a volatile or non-volatile data storage device. For example, the computer-readable medium may be a hard drive, a USB (universal serial bus) storage device, a RAM (random-access memory), a ROM (read-only memory), an EPROM (erasable programmable read-only memory), an EEPROM (electrically erasable programmable read-only memory), a flash memory or a combination of at least two of these examples. The computer-readable medium may also be a data communication network for downloading program code, such as the Internet or a cloud.

It should be noted that features of the methods described above and below may also be features of the data processing device, the computer program and the computer-readable medium (and vice versa).

Embodiments of the invention may be regarded as based on the ideas and findings described below without limiting the invention.

According to an embodiment, the first reward value may be determined as the second reward value. In other words, the first reward value and the second reward value may be identical, meaning that the different artificial neural networks are trained using the same reward value. This has the effect of forcing the artificial neural networks to collaborate with each other to obtain better rewards in the future. Alternatively, the first reward value and the second reward value may differ from each other and/or may be determined by different reward functions.

According to an embodiment, the first reward value may be additionally increased or decreased by an amount proportional to the first output value. For example, the amount used to increase or decrease the first reward value may be a linear function of the first output value.

According to an embodiment, the second reward value may be additionally increased or decreased by an amount proportional to the second output value. For example, the amount used to increase or decrease the second reward value may be a linear function of the second output value.

According to an embodiment, each reward value may be a function of at least one of the following inputs determined during updating the environment: an energy consumption of the elevator, an average time required to fulfil each call. For example, reducing the energy consumption and/or decreasing the average time may increase each reward value. It is possible that each reward value is a function of different inputs. In this case, the different inputs may be weighted with different weights. Thus, each artificial neural network can be trained to achieve either the lowest possible energy consumption or the shortest possible average time or a compromise between both.

Each reward value may additionally be a function of at least one of the following inputs: a number of fulfilled calls, a number of passengers inside each car. The number of fulfilled calls may be a number of calls fulfilled by the elevator since the end of the last simulation step and/or since the last state transition.

According to an embodiment, the training data for each artificial neural network may further include at least one of the following data from the past simulation steps: at least a part of the current state of the environment, at least a part of a next state of the environment, the assignment, the first output value, the second output value. The next state may immediately follow the current state. Such training data may be used, for example, to train each artificial neural network using a value-based learning algorithm, also known as Q learning. The assignment, which results from assigning the new call to the selected car, may be seen as an action selected at the simulation step by the respective agent. The training may be done in a series of training steps. In each training step, the training data may be sampled from a certain number of records stored in a memory, each record including the above-mentioned data from one of the past simulation steps.

According to an embodiment, the method for controlling the elevator may further comprise generating a control command to cause the selected car to fulfil the new call. The control command may be generated to control a movement of the selected car along one of the vertical axes, e.g. along a shaft of the building. The control command may be generated considering the other calls assigned to the selected car. Examples for such a control command are “go up”, “go down”, “go to floor X” or “go to the next floor”. The control command may also cause the selected car to close and/or open its door(s) and/or to fulfil the other calls assigned to it.

According to an embodiment, the first input data may encode at least the current position of the first car, the current calls assigned to the first car and the new call. The first input data may additionally encode the current position of the second car and/or the current calls assigned to the second car.

According to an embodiment, the second input data may encode at least the current position of the second car, the current calls assigned to the second car and the new call. The second input data may additionally encode the current position of the first car and/or the current calls assigned to the first car.

As mentioned above, the current state and/or the sensor data may further include, for example, a current moving direction (e.g. “up”, “down”, “stopped”) and/or a current occupancy (e.g. “full”, “not full”) of each car. In this case, the first input data may additionally encode the current moving direction and/or the current occupancy of the first car (and, optionally, of the second car) and/or the second input data may additionally encode the current moving direction and/or the current occupancy of the second car (and, optionally, of the first car).

In other words, it is possible that each agent sees information relating to not only its own state but also the state of any other agent.

This may improve the accuracy of the method.

According to an embodiment, the selected car may be the car corresponding to the lowest or highest output value.

According to an embodiment, the processor of the data processing device may be configured to carry out the method of the second aspect of the invention according to an embodiment where a control command is generated. In this case, the elevator may further comprise an actuator system adapted to control the cars according to control commands generated by the data processing device.

Advantageous embodiments of the invention are described in more detail below with reference to the attached drawings. Neither the description nor the drawings are to be construed as limiting the invention.

### DESCRIPTION OF THE DRAWINGS

FIG. 1 shows a block diagram illustrating the simulation of an elevator in a method according to an embodiment of the invention.

FIG. 2 shows a block diagram illustrating the training of an artificial neural network in a method according to an embodiment of the invention.

FIG. 3 shows an elevator according to an embodiment of the invention.

FIG. 4 shows a data processing device according to an embodiment of the invention.

The figures are merely schematic and not to scale. Identical reference signs in the drawings denote identical features or features having the same effect.

### DETAILED DESCRIPTION

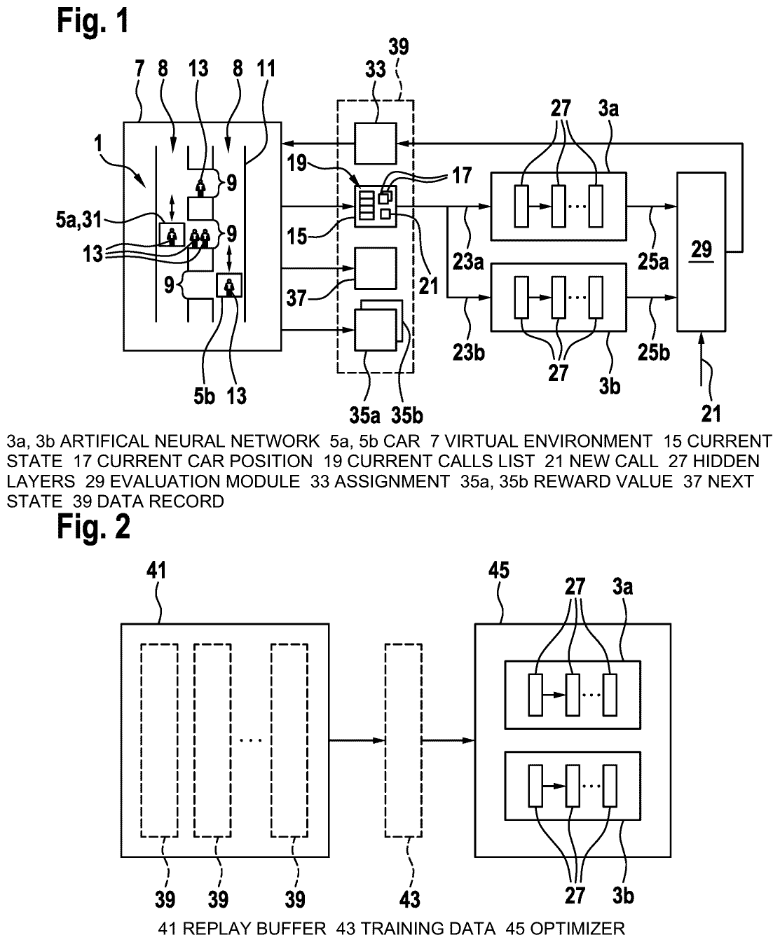

FIG. 1 illustrates the simulation of an elevator 1 as part of a training method for training multiple artificial neural networks 3a, 3b to assign calls to cars 5a, 5b of the elevator 1.

The elevator 1 is simulated in a virtual environment 7 in which a virtual first car 5a and a virtual second car 5b (or more than two virtual cars) of the elevator 1 move along different vertical shafts 8 between different floors 9 of a virtual building 11 in reaction to calls from virtual passengers 13. Each call indicates a desired floor at which one of the cars 5a, 5b should stop.

The simulation is performed in a series of simulation steps. At each simulation step, the environment 7 determines its current state 15 including a current position 17 of each car 5a, 5b with respect to the floors 9, a list 19 of current calls assigned to the cars 5a, 5b and a new call 21 to be assigned to one of the cars 5a, 5b.

At least a part of the current state 15 may be converted into first input data 23a and second input data 23b. For example, the first input data 23a may encode the current position 17 of the first car 5a, the current calls assigned to the first car 5a and the new call 21, whereas the second input data 23b may encode the current position 17 of the second car 5b, the current calls assigned to the second car 5b and the new call 21.

The current state 15 may include additional data such as a current moving direction or a current occupancy of each car 5a, 5b. In this case, the first input data 23a may further encode the current moving direction and/or the current occupancy of the first car 5a, whereas the second input data 23b may further encode the current moving direction and/or the current occupancy of the second car 5a.

Alternatively, the first input data 23a may encode a possible order of desired floors at which the first car 5a should stop and/or the second input data 23b may encode a possible order of desired floors at which the second car 5b should stop. The possible order may be determined depending on the current position 17, the current calls, the new call 21, the current moving direction or the current occupancy of the respective car 5a, 5b or a combination of at least two of these parameters.

In particular, each input data 23a, 23b may encode the complete current state 15, i.e. all of the above-mentioned data included in the current state 15.

The first input data 23a is then input into a first artificial neural network 3a configured to convert the first input data 23a into a first output value 25a indicating a probability and/or tendency for the first car 5a to be assigned to the new call 21.

In parallel, the second input data 23b is input into a second artificial neural network 3b configured to convert the second input data 23b into a second output value 25b indicating a probability and/or tendency for the second car 5b to be assigned to the new call 21.

Each neural network 3a, 3b may comprise a plurality of hidden layers 27 with trainable parameters for converting the respective input data 23a, 23b into the respective output value 25a, 25b.

The output values 25a, 25b may be Q values and/or bid values, for example.

Next, the output values 25a, 25b are input into an evaluation module 29 that analyzes the output values 25a, 25b to determine one of the cars 5a, 5b as a selected car 31. For example, the selected car 31 may be the car corresponding to the lowest output value. Here, the first output value 25a is the lowest output value. Thus, the first car 5a is determined as the selected car 31. Alternatively, the car corresponding to the highest output value may be determined as the selected car 31.

During training of the networks 3a, 3b, the selected car 31 may be determined with a certain degree of randomness, e.g. using an epsilon-greedy algorithm.

The evaluation module 29 then assigns the new call 21 to the selected car 31. This assignment 33 may cause the environment 7 to update its state, e.g. by moving the selected car 31 away from its current position 17 according to the new call 21. Doing this, the environment 7 calculates a first reward value 35a and a second reward value 35b that both quantify a usefulness of the assignment 33, e.g. with regard to an average waiting and/or travelling time of the passengers 13 and/or an energy consumption of the elevator 1.

Both reward values 35a, 35b may be one and the same reward value. However, it is also possible that the reward values 35a, 35b are output by different reward functions. The reward values 35a, 35b are used to train the neural networks 3a, 3b, as described below. The assignment 33 may further cause the environment 7 to determine a transition from the current state 15 into a next state 37, which may include the same types of data as the current state 15, e.g. a next position of each car 5a, 5b, an updated version of the list 19 of current calls and a next new call.

In this example, a record 39 of the data generated at each simulation step, e.g. including the current state 15, the next state 37, the assignment 33 and the reward values 35a, 35b, may be stored in a replay buffer 41 (see FIG. 2). The records 39 of past simulations steps may be used to generate training data 43 for training the neural networks 3a, 3b.

FIG. 2 illustrates the training part of the training method. The training may comprise a series of training steps. In each training step, a batch of N records 39 may be sampled and used as the training data 43.

The sampling may be done in such a way that the training data 43 for training the first neural network 3a includes the first reward values 35a from the past simulation steps and the training data 43 for training the second neural network 3b includes the second reward values 35b from the past simulation steps. The training data 43 for the different neural networks 3a, 3b may be identical or differ from each other.

The training data 43 may further include the following data from the past simulation steps: at least a part of the current state 15, at least a part of the next state 37, the assignment 33 (as the selected action).

Such training data may be used to train the neural networks 3a, 3b using a value-based learning algorithm (“Q learning”). Alternatively, a policy-based learning algorithm or a combination of both may be used. Examples for suitable learning algorithms are “Deep Q Networks” or “Distributed Prioritized Experience Replay (Ape X)” as implemented in RLlib.

In principle, the training is performed in a series of training steps in which an optimizer 45 adjusts the weights of each neural network 3a, 3b depending on the respective reward values 35a, 35b so that assignments 33 performed at future simulations steps are more useful than those performed at the past simulation steps. The optimization may be done through backpropagation using stochastic gradient descent, for example. The training steps may be performed in parallel or alternately with the simulation steps until a global or local optimum is achieved.

For example, as mentioned above, the reward values 35a, 35b may be related to the average time required to fulfil each call and/or the energy consumption of the elevator 1. This forces the neural networks 3a, 3b to collaborate with each other.

Alternatively, the first reward value 35a may be additionally decreased (or increased) if the new call 21 is assigned to the first car 5a, whereas the second reward value 35b may be additionally decreased (or increased) if the new call 21 is assigned to the second car 5b. The amount by which each reward value 35a, 35b is decreased (or increased) may be proportional to the respective output value 25a, 25b. This forces the neural networks 3a, 3b to compete with each other.

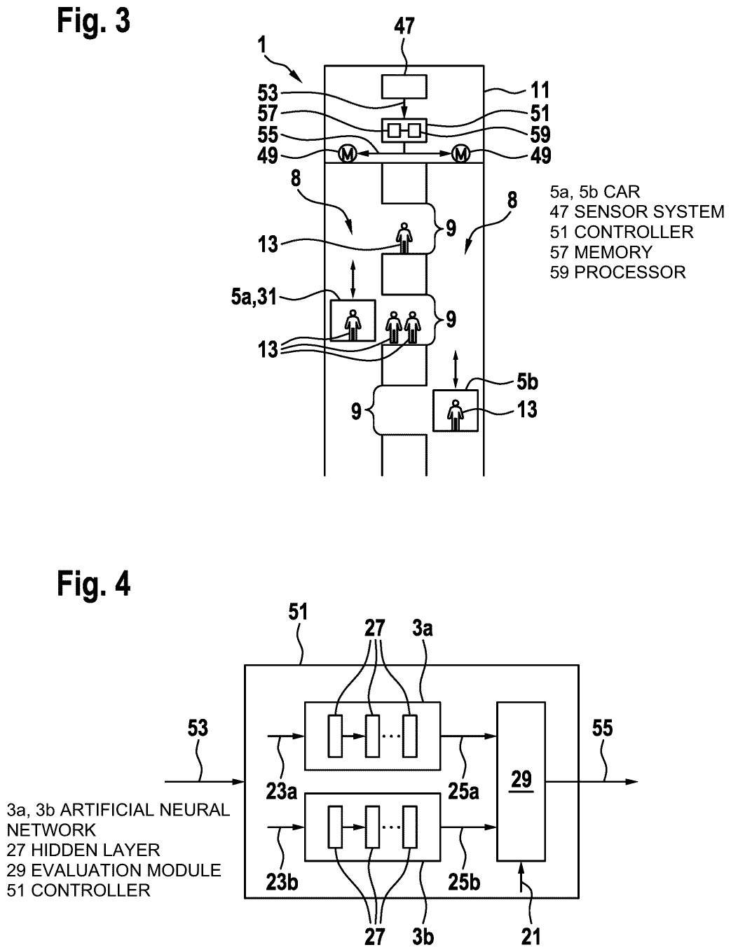

The trained neural networks 3a, 3b may be used in a real version of the elevator 1, as shown in FIG. 3.

Similar to the simulated version, the real version of the elevator 1 comprises a first car 5a and a second car 5b arranged to be movable along different vertical shafts 8 between different floors 9 of a real building 11 to transport real passengers 13.

The elevator 1 further comprises a sensor system 47, an actuator system 49 (e.g. including an electric drive “M” for each car 5a, 5b) and a controller 51 as a data processing device.

The sensor system 47 is adapted to generate sensor data 53 that encode a current state of the elevator 1. For example, the sensor data 53 may include the same types of data as the current state 15 of the environment 7.

The actuator system 49 is adapted to control the cars 5a, 5b, e.g. to accelerate and decelerate them and to close and open their doors, according to control commands 55 generated by the controller 51.

The controller 51 comprises a memory 57 and a processor 59 configured to carry out the following method for controlling the elevator 1, i.e. for generating the control commands 55, by executing a computer program stored in the memory 57 (see also FIG. 4).

At a first step, the sensor data 53 is received in the controller 51.

At a second step, at least a part of the sensor data 53 is converted into first input data 23a and second input data 23b. For example, the (real) input data 23a, 23b may include the same types of data as the (virtual) input data 23a, 23b generated by the environment 7.

At a third step, the first input data 23a is input into the trained first neural network 3a. In parallel, the second input data 23b is input into the trained second neural network 3b.

At a fourth step, the resulting output values 25a, 25b are input into an evaluation module 29 that analyses them to determine one of the cars 5a, 5b as a selected car 31. In this example, the selected car 31 is the one corresponding to the lowest output value, here the first car 5a.

At a fifth step, the evaluation module 29 assigns the new call 21 included in the sensor data 53 to the selected car 31.

At a sixth step, the evaluation module 29 may generate a control command 55 to cause the selected car 31 to fulfil the new call 21 and, additionally, any other call currently assigned to the selected car 31.

The processor 59 may additionally be configured to carry out the above training method.

The modules described above may be software and/or hardware modules.

In summary, a bidding-based strategy as implemented by the methods described above may enable the elevator to transport passengers to their final destinations in the shortest possible time while consuming as little energy as possible.

Finally, it is noted that terms such as “comprising”, “including”, “having” or “with” do not exclude other elements or steps and that the indefinite article “a” or “an” does not exclude a plurality. It is further noted that features or steps described with reference to one of the above embodiments may also be used in combination with features or steps described with reference to any other of the above embodiments.

In accordance with the provisions of the patent statutes, the present invention has been described in what is considered to represent its preferred embodiment. However, it should be noted that the invention can be practiced otherwise than as specifically illustrated and described without departing from its spirit or scope.

1-14. (canceled)

15. A computer-implemented method for training multiple artificial neural networks to assign calls to cars of an elevator, the method comprising steps of:
simulating, by performing a series of simulation steps, an environment in which a first car and a second car of the elevator move along different vertical axes between different floors of a building in reaction to calls indicating desired floors of the building, wherein each of the simulation steps comprises:
determining a current state of the environment, the current state including a current position of each of the first and second cars with respect to the floors, a list of current calls assigned to each of the first and second cars and a new call to be assigned to one of the first and second cars;
inputting first input data encoding at least a part of the current state into a first artificial neural network converting the first input data into a first output value indicating a probability and/or tendency for the first car to be assigned to the new call;
inputting second input data encoding at least a part of the current state into a second artificial neural network converting the second input data into a second output value indicating a probability and/or tendency for the second car to be assigned to the new call;
determining one of the first and second cars as a selected car using the first output value and the second output value;
updating the environment by assigning the new call to the selected car and determining a first reward value and a second reward value, wherein each of the first and second reward values quantifies a usefulness of the assignment of the new call;
training the first artificial neural network using training data including the first reward values from past ones of the simulation steps and training the second artificial neural network using training data including the second reward values from the past ones of the simulation steps, the training increasing a usefulness of assignments performed in future ones of the simulation steps; and
wherein the first reward value is increased or decreased when the new call is assigned to the first car as the selected car and/or wherein the second reward value is increased or decreased when the new call is assigned to the second car as the selected car.

16. The method according to claim 15 wherein the first reward value is equal to the second reward value.

17. The method according to claim 15 wherein the first reward value is increased or decreased by an amount proportional to the first output value, and/or wherein the second reward value is increased or decreased by an amount proportional to the second output value.

18. The method according to claim 15 wherein each of the first and second reward values is a function of at least one of inputs determined during the updating the environment step, the inputs being: an energy consumption of the elevator and an average time required to fulfil each of the assigned calls.

19. The method according to claim 15 wherein the training data for each of the first and second artificial neural networks further includes at least one of selected data from the past simulation steps, the selected data being: at least a part of the current state of the environment, at least a part of a next state of the environment, the assignment of the new call, the first output value, and the second output value.

20. A data processing device comprising a processor configured to perform the method according to claim 15.

21. An elevator comprising:
a first car and a second car movable along different vertical axes between different floors of a building;
a sensor system providing sensor data indicative of a current state of the elevator, wherein the sensor data includes a current position of each of the first and second cars with respect to the floors, a list of current calls assigned to the first and second cars and a new call to be assigned to one of the first and second cars, wherein the assigned calls and the new call indicate a destination floor corresponding to one of the floors; and
the data processing device according to claim 20 receiving the sensor data and controlling the movement of the first and second cars.

22. The elevator according to claim 21 including actuator system adapted to control the first and second cars according to control commands generated by the data processing device.

23. A computer program comprising instructions stored on a non-transitory computer-readable medium wherein the instructions when executed by a processor of an elevator controller cause the elevator controller to perform the method according to claim 15.

24. A non-transitory computer-readable medium comprising instructions stored thereon wherein the instructions when executed by a processor of an elevator controller cause the processor to carry out the steps of the method according to claim 15.

25. A computer-implemented method for controlling an elevator, wherein the elevator includes a first car and a second car movable along different vertical axes between different floors of a building and a sensor system providing sensor data indicative of a current state of the elevator, the method comprising steps of:
receiving the sensor data that includes a current position of each of the first and second cars with respect to the floors, a list of current calls assigned to the first and second cars and a new call to be assigned to one of the first and second cars, wherein each of the assigned calls and the new call indicates a desired one of the floors;
inputting first input data generated from at least a part of the sensor data into a first artificial neural network converting the first input data into a first output value indicating a probability and/or tendency for the first car to be assigned to the new call;
inputting second input data generated from at least a part of the sensor data into a second artificial neural network converting the second input data into a second output value indicating a probability and/or tendency for the second car to be assigned to the new call, wherein the first and second artificial neural networks have been trained with the method according to claim 15;
determining one of the first and second cars as a selected car using the first output value and the second output value; and
assigning the new call to the selected car.

26. The method according to claim 25 including generating a control command causing the selected car to fulfil the new call.

27. The method according to claim 25 wherein the first input data encodes at least the current position of the first car, the current calls assigned to the first car and the new call, and/or wherein the second input data encodes at least the current position of the second car, the current calls assigned to the second car and the new call.

28. The method according to claim 25 wherein the selected car is a one of the first and second cars corresponding to a lower or a higher of the first and second output values.

29. A data processing device comprising a processor configured to perform the method according to claim 25.

30. An elevator comprising:
a first car and a second car movable along different vertical axes between different floors of a building;
a sensor system providing sensor data indicative of a current state of the elevator, wherein the sensor data includes a current position of each of the first and second cars with respect to the floors, a list of current calls assigned to the first and second cars and a new call to be assigned to one of the first and second cars, wherein the assigned calls and the new call indicate a destination floor corresponding to one of the floors; and
the data processing device according to claim 29.

31. The elevator according to claim 30 including actuator system adapted to control the first and second cars according to control commands generated by the data processing device.

32. A computer program comprising instructions stored on a non-transitory computer-readable medium wherein the instructions when executed by a processor of an elevator controller cause the elevator controller to perform the method according to claim 25.

33. A non-transitory computer-readable medium comprising instructions stored thereon wherein the instructions when executed by a processor of an elevator controller cause the processor to carry out the steps of the method according to claim 25.
